(19) United States
(12) Patent Application Publication
(10) Pub. No.: US 2002/0150097 A1
(43) Pub. Date: Oct. 17, 2002

(54) Method and apparatus for secured multicasting

(76) Inventors: Wei Yen, Dunwoody, GA (US); Dexiang John Xu, Suwanee, GA (US); Meredith Ann Schelp, Atlanta, GA (US)

Correspondence Address: MORRISON & FOERSTER, LLP, 555 WEST FIFTH STREET, SUITE 3500, LOS ANGELES, CA, 90013-1024, US

(21) Appl. No.: 09/790,020

(22) Filed: Feb. 21, 2001

(51) Int. Cl. H04L 12/56; H04K 1/00

(52) U.S. Cl. 370/390; 370/399; 370/432; 380/283

(57) ABSTRACT

A method and apparatus for conducting secured multicast in an asynchronous transfer mode based passive optical network communication (“APON”) system having a central network device, such as an optical line terminal (“OLT”), and multiple network devices, such as optical network terminals (“ONT”), whereby the central network device communicates with the network devices using multicast encryption key that is selected or generated from among the churning keys belonging to the network devices, and whereby the central network device periodically updates the multicast encryption key by delivering to the network devices the difference values between the updated multicast encryption key and the respective churning key of each network device.

### BACKGROUND

1. Field of Invention

The present invention is directed to a method and apparatus for secured multicasting. Specifically, the present invention relates to secured multicasting over an APON (Asynchronous Transfer Mode based Passive Optical Network) system.

2. Description of Related Arts

Before describing the details of the present invention, it is helpful to discuss the various technologies that are relevant to the present invention, including multicast, asynchronous transfer mode (“ATM”) communication, and ATM based passive optical networks (“APON”).

Multicast refers generally to the broadcast of messages to a selected group of workstations on a Local Area Network (LAN), a Wide Area Network (WAN), or the Internet (IP Multicast). Multicast involves communication between a single device and multiple members of a communication group. Generally, it is more efficient to distribute data to multiple users via multicast than it is by transmitting the same data to all the users individually. More specifically, by making the distribution at a network level, multicast reduces the number of data packets being routed with the network as compared to multiple unicasts. An elementary example of multicasting is the transmission of an e-mail message to multiple receivers. Other examples of multicast include teleconferencing and videoconferencing, which require more sophisticated protocols such as Transmission Control Protocol/Internet Protocol (TCP/IP). Conventionally, communication via multicast is unsecured. As with any unsecured communication, an unintended recipient of the data may intercept the data and gain access to information that may be considered confidential or private. Although multicast was first introduced in the late 1980s, its adoption has been relatively slow due to various issues such as scalability and developing a standardized protocol.

Asynchronous transfer mode, commonly referred to as ATM, is well known in the art of network communications. ATM refers generally to a relatively high speed, connection-oriented communication method that uses data packet switching and multiplexing techniques. In a communication system employing ATM, data streams, such as voice or text data, are broken down into data packets that include header and information fields. The data packets are usually fifty-three bytes in size, and are routed independently through a network of interconnected nodes such that the family of data packets eventually reach a common destination. The data packets are then re-sequenced in the order they were sent. ATM is commonly used in today's network and telephone communication systems. With the development of passive optical networks (“PON”), it is currently anticipated by the industry that future ATM communication as protocol will be deployed via PON. An ATM based PON is also known as APON, which is discussed in further detail below.

A passive optical network transporting ATM data packets can support multiple services offering data, voice, and video transportation with dynamic bandwidth allocation and a higher quality of service (QoS). The Full Service Access Networks (“FSAN”) committee, made of an international group of network operators and vendors, has produced a set of technical specifications defining open optical interfaces to the APON. These technical requirements have been accepted by the International Telecommunication Union-Telecommunication in the ITU-T G.983.1 standard, the entire text of which is hereby incorporated by reference for background purposes. The ITU-T G983.1 standard fundamentally defines APON in terms of architecture, optical network requirements, and transmission methodology. Under the G.983.1 standard, APON architecture consists of three major components:

The Optical Line Terminal (OLT),

The Optical Distribution Network (ODN), and

The Optical Network Unit/Terminal (ONU/ONT).

The OLT manages all APON related aspects of the ATM transport system. The ODN provides a totally passive optical transmission means between the OLT and the ONUs via optical fiber and optical splitters. The ONU and ONT terminate the PON and provide service interfaces to the end user. For simplicity in the context of this document, ONT is representative of either an ONU or an ONT since they both terminate the PON. In APON systems as defined in G.983.1, duplex (e.g., bi-directional) transmission occurs at the 1310 nm and 1550 nm wavelength regions over a single fiber for upstream and downstream transmission, respectively. The downstream signal is broadcast from the OLT to all ONTs on the PON. The upstream bandwidth incorporates Time Division Multiple Access (TDMA) such that the OLT controls the upstream transmission from each ONT via grants in the downstream. Thus, according to G.983.1, all traffic from the OLT is broadcast to all ONTs on the same PON.

As previously mentioned, multicasting can be defined as the communication between a single device and multiple members of a device group. That is, multicasting can be defined as unidirectional point to multi-point transmission. Classically, multicasting has been defined for workstations on a LAN, WAN, or the Internet. Traditionally, multicasting in the ATM environment involves the ATM switch copying the same cells multiple times to different destinations, which not only increases data traffic, but also causes congestion. Multicasting has not been defined for APON systems.

### SUMMARY OF THE INVENTION

The present invention will provide the network provider the benefit of offering multicasting services over an APON system. That is, only one copy of the information will be sent down the PON to all receivers, such as ONTs, instead of having to send one copy for each ONT on the PON requesting the multicasting service. Multicasting reduces the amount of bandwidth required to send the information since it requires only one copy of information to be sent to all recipients. The predetermined group of recipients will receive the multicast data via multicasting virtual path identification/virtual channel identification (“VPI/VCI”), which are field headers in ATM cell packets that identify virtual paths or virtual channels over which a cell packet is to travel. This methodology removes the burden on the ATM switch fabric normally incurred during conventional multicasting methodology. The multicast connection in accordance with a preferred embodiment of the present invention is also secured via a multicasting churning key (i.e., encryption key) to prevent eavesdropping by unauthorized users. In particular, preferred embodiments of the present invention facilitates secured multicasting over an APON system by assigning a multicasting session with a unique VPI/VCI for each subscribing ONT and by using multicasting churning key during communication with the subscribing ONTs.

Preferred embodiments of the present invention provides the advantages of multicasting to select multiple recipients in the APON system while providing security via a churning key. In doing so, the present invention is most effective when operated within the standard APON architecture as defined in ITU-T G.983.1. Specifically, preferred embodiment of the present invention first establishes the various connections for multicasting channels, sets up a churning key and provides differential update to each of the recipients, and allows for transparent joining/leaving of an ONT from the secure multicasting group.

Multicasting connections are provisioned through a systems manager, such as an element management system, such that the multicasting features are assigned to a reserved VPI/VCI by the central server (such as an OLT). Initially, the OLT will request in the downstream broadcast that all ranged ONTs on the APON send a unique multicasting churning key. Only ONTs with the multicasting feature will respond in the upstream to the OLT. In accordance with the preferred embodiment of the present invention, for each multicasting group (ONTs with multicasting feature who have subscribed to the same multicast group), a multicasting leader is preferably assigned.

Alternative methods may be used in selecting a multicast group leader. For example, the ONT whose multicasting churning key is received first may be designated as the leader from which all churning key updates will be based. The leader ONT's churning key is then updated at a given churning key interval via request for new churning key by the OLT. Another method of multicasting leader selection can be based on an identification number, such as serial number, of the ONT. For example, the ONT with the minimum or maximum identification number in the multicasting group may be selected as the leader of the multicasting group. Thus, the main importance is the necessity to select a leader of the multicasting group and not necessarily the method used to select the leader.

Churning key updates are sent in the downstream path by the OLT to ONTs in multicasting group. The churning key updates may be delivered using a variety of methods. One possible scheme is that the churning key updates sent in the downstream to the multicasting group consist of only the difference between the leader ONT's current multicasting churning key and each particular ONT's churning key. Sending the difference between churning keys is the simplest method to update the churning keys. More complex algorithms, such as using a private key to scramble the information, may be used to code the multicasting churning key and individual ONT's churning keys before sending them down. Whichever scheme is used to update the churning key in the downstream, the schema preferably transparently allow the leader ONT or member ONTs to leave the multicasting group and preferably allow new ONTs to join the multicasting group without interrupting service. Messages between OLT and ONTs pertaining to multicasting features may be sent multiple times to ensure accuracy, confirm receipt of transmission, or to monitor and address any possible security breach.

As previously mentioned, one advantage of the present invention includes removing the traditional burden on the ATM switch fabric typically associated with standard multicasting methods. The present invention takes advantage of the broadcast nature of APON system to multicast data to ONTs with assigned multicasting VPI/VCI. At the same time, the multicasting churning key scheme provides privacy against eavesdropping by unauthorized or potentially malicious third parties.

### BRIEF DESCRIPTION OF THE DRAWINGS

FIG. 1 is a schematic illustration of an APON configuration in an access network.

FIGS. 2 to 5 are schematic illustrations of one aspect of the present invention in accordance with the preferred embodiment.

FIGS. 6 to 9 are schematic illustration of another aspect of the present invention in accordance with the preferred embodiment.

FIG. 10 to 15 are schematic illustrations of yet another aspect of the present invention in accordance with the preferred embodiment.

### DETAILED DESCRIPTION OF THE PREFERRED EMBODIMENTS

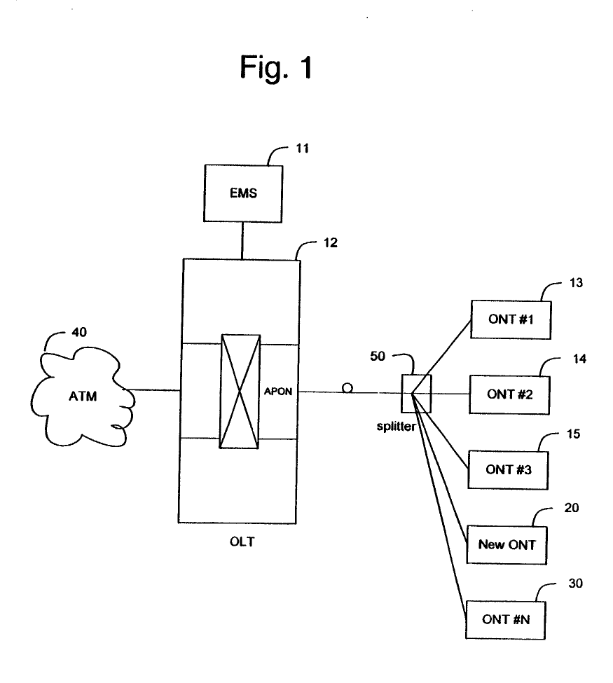

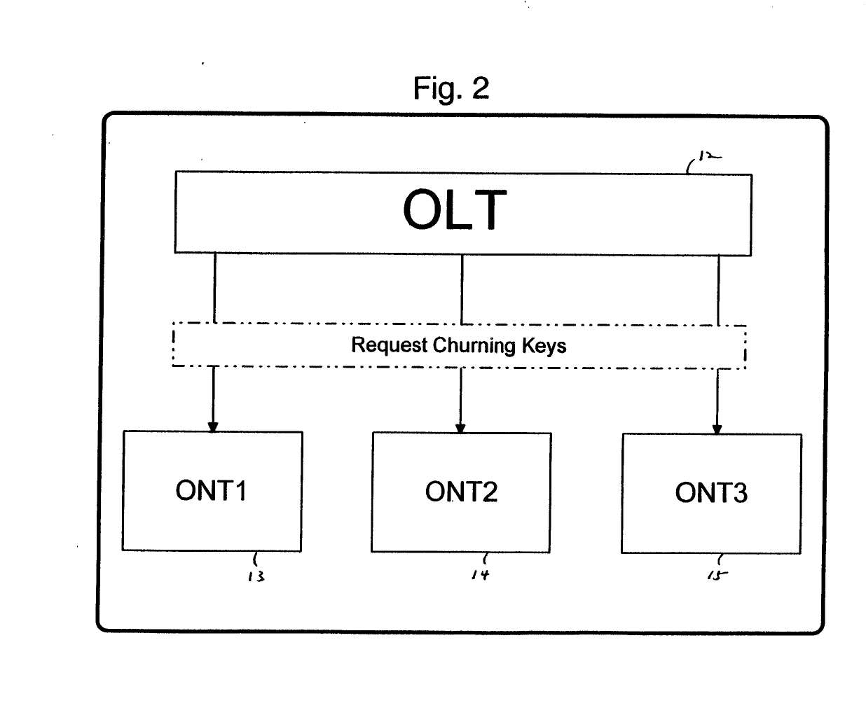

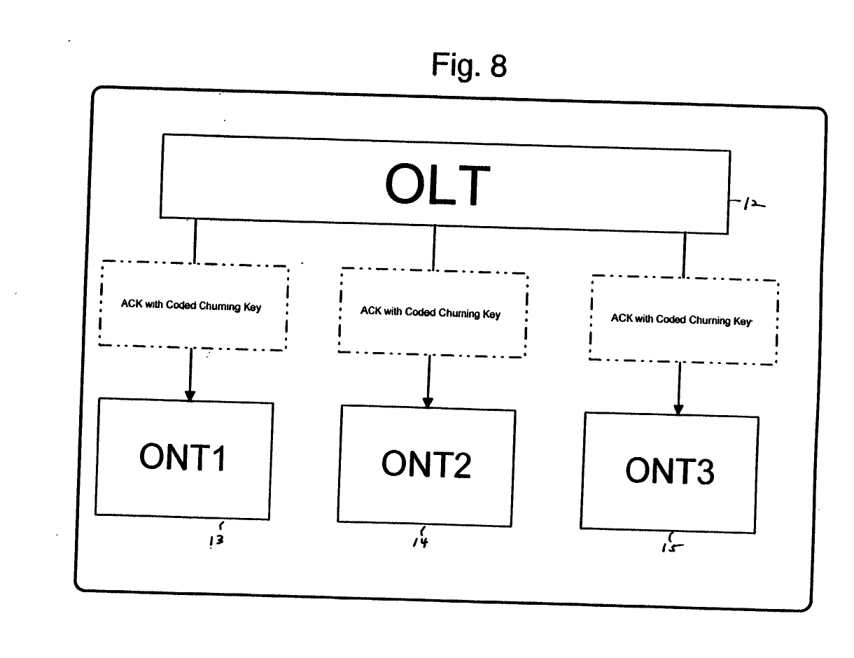

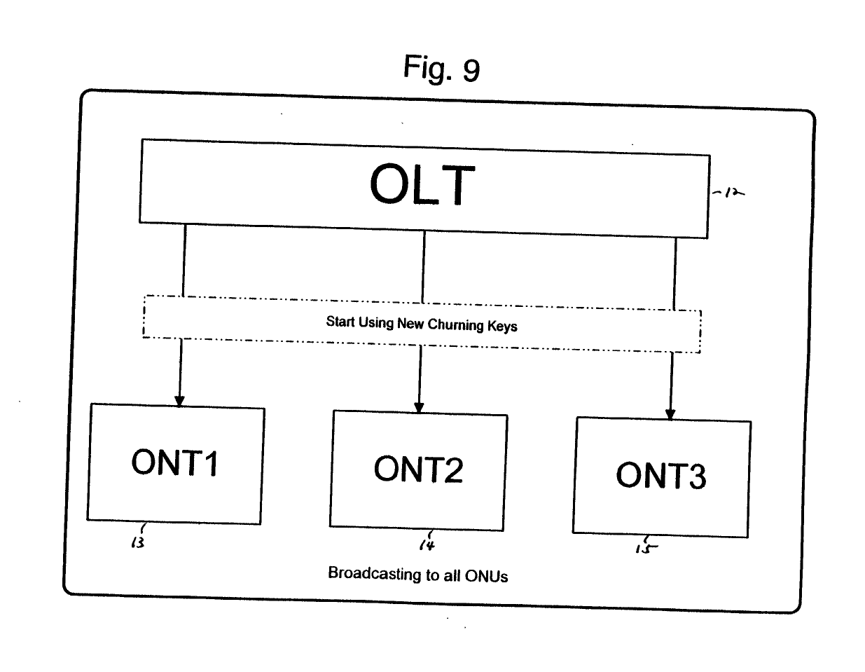

The preferred embodiments of the present invention will now be described with references to FIGS. 1 through 15. It should be noted that although the figures use an APON configuration as a sample application of the preferred embodiment of the present invention, it should be understood by one skilled in the art that the present invention can be applied in other types of communication network, including wireless networks. It should also be noted that, in FIGS. 2-15, the OLT 12 may communicate with multiple ONTs 13-15 via either single point of communication or via parallel ports of communication. The multiple lines of communication in FIG. 2 through 15 is an illustration of schematics only and does not restrict the present invention to either single point communication or multiple point communication between the OLT and the ONTs. In the case of single point of communication, the data transmitted to the various ONTs can be split or replicated by a broadcast or a split device, such as an optical splitter, for transmission to all the receiving ONTs.

FIG. 1 illustrates an APON multicast configuration to be used in access networks in accordance with the preferred embodiment of the present invention. The Optical Line Terminator (OLT) 12 is an ATM switch that bridges an access network to a core network. The Element Management System (EMS) 11 manages and maintains the access network elements, which include the OLT and various Optical Network Terminators (ONT) 13-15. The ONTs may be connected to the OLT via various different kinds of network configurations. In FIG. 1, the ONTs are connected to the OLT via an Optical Distribution Network (ODN) that uses intermediate optical network components such as a passive splitter 50. Using the ODN, data may be broadcasted from the OLT to all the ONTs.

For purposes of illustration only, in FIG. 1, ONTs 13, 14, and 15 are subscribers to the multicast service, ONT 30 does not subscribe to the multicasting service, and new ONT 20 is a new member to the multicast subscription service, wherein ONT 20 joins the multicast group after a multicast session for ONTs 13, 14, and 15 has begun. Through the EMS, all ONTs with multicasting features that subscribe to multicasting service are assigned a Virtual Path Identification (“VPI”) or a Virtual Channel Identification (“VCI”). More specifically, when an ONT seeks to become a registered subscriber, its request is sent to the EMS, which then may, pending approval, assign the requesting ONT with a VPI or VCI that identifies the ONT as a subscriber. The multicasting VPI/VCI is preferably reserved for such purpose only. The OLT is then informed by the EMS of which ONT are subscribers to the multicast services, and preferably uses the assigned VPI/VCls for sending data to those ONTs.

After all of the ONTs (ONT#1-ONT#N, but not including New ONT) are registered with the EMS, and before the provision or multicasting service, the OLT will request all ONTs to send a unique multicasting churning/encryption key. The ONTs with multicasting feature will each respond with a unique churning key to the OLT. Multiple transmission is preferably used for reliable communication whenever critical information is passing between OLT and ONTs, such as churning key updates.

In accordance with the preferred embodiment of the present invention, a single ONT in the multicasting group is preferably selected as the multicast group leader. Multicasting leader selection can be accomplished via many different methods. For instance, the first ONT sending the churning key can be selected as the group leader for multicasting. Once the ONT group leader is chosen, its churning key can then be used to scramble the multicasting message that are transmitted to all the ONTs in multicasting group. However, prior to transmitting the scrambled message to all the subscribing ONTs, the OLT preferably sends to all the other subscribing ONTs the group leader ONT's churning key. Thereafter, the ONTs in the multicasting group will periodically receive from the OLT updated churning key to de-churn the message. The method used to deliver the churning key, and updates of the churning key, can be accomplished in many different ways. In accordance with one embodiment of the present invention, multicast subscriber ONTs that are not the group leader ONT can receive the XOR product between the multicasting churning key (i.e., the group leader ONT's churning key) and their own churning key. One advantage of sending the XOR product rather than the multicast key is that the key itself does not have to be transmitted over the ODN, reducing the likelihood of third-party interception of the multicast key. In that embodiment, before de-churning the message, each ONT preferably derive the multicast key by using its own churning key and the received XOR product. The equation below is an example of how a multicasting key may be derived given an ONT's own churning key and a received XOR product between its own churning key and the multicasting key:

D_{CKi}=M_{CK} xor CKi;

In this formula, D_{CKi} is the XOR product between the multicasting churning key and the churning key for ONT number 1, M_{CK} is Multicasting Churning Key which is equal to the churning key from the leader of multicasting group, and CKi is the Churning Key reported by ONT1. An example of churning key recorded in OLT is shown in Table 1.

TABLE 1
Sample Churning key tracking table at OLT

| | | | XOR Product with Group |
|---|---|---|---|
| | | Churning | Leader/Multicasting Key |
| Sequence # | ONT number | Keys (CK) | (DCK) |
| 1 | 1 (Group Leader) | 0xA029BD | N/A |
| 2 | 2 | 0x145ACE | 0xB47373 |
| 3 | 3 | 0x39AFE3 | 0x99865E |

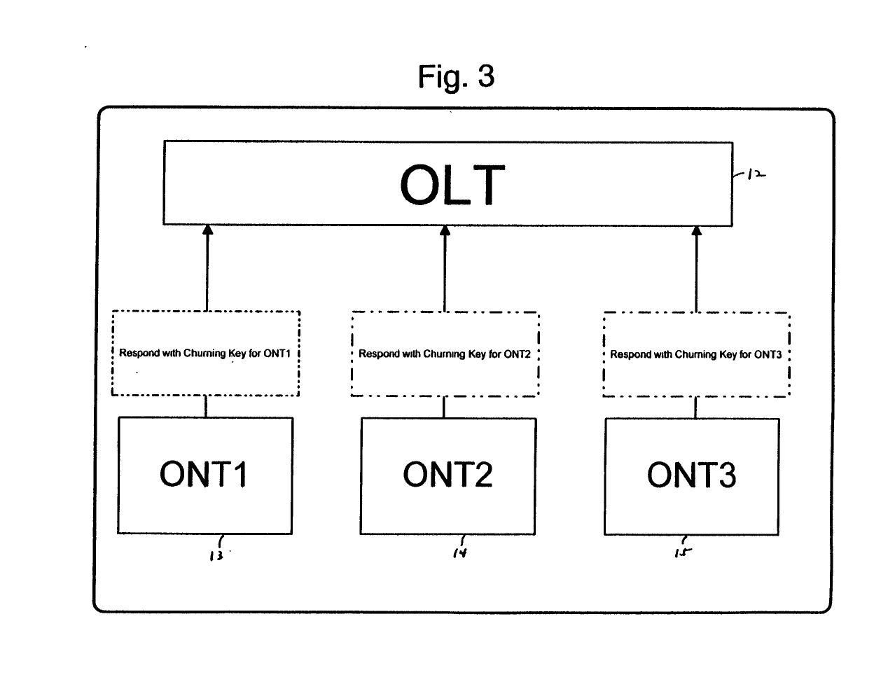

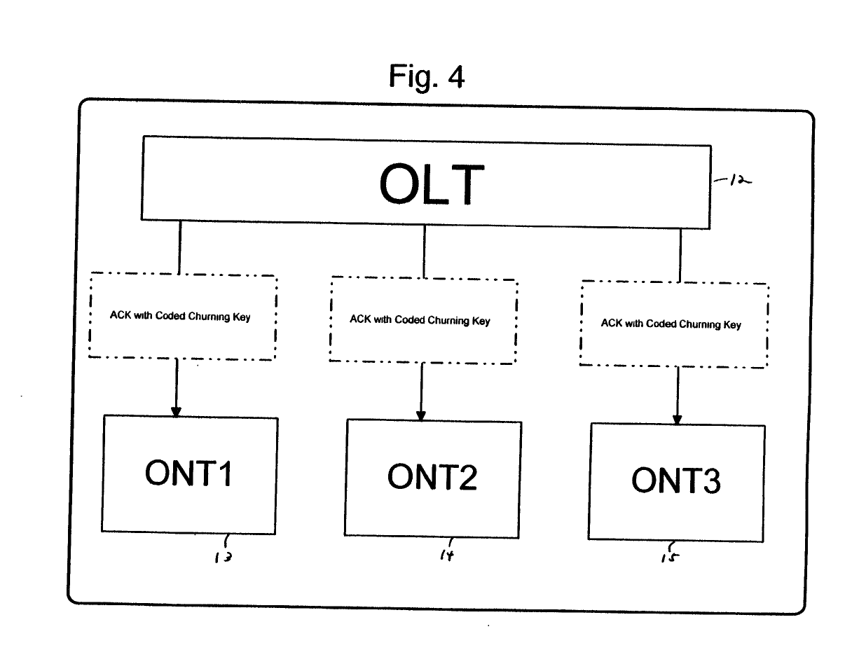

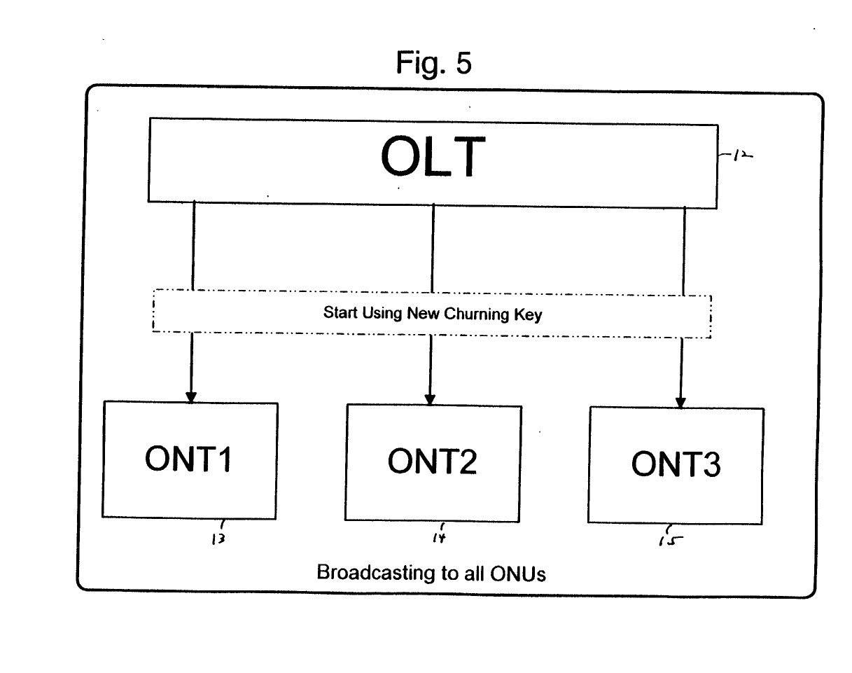

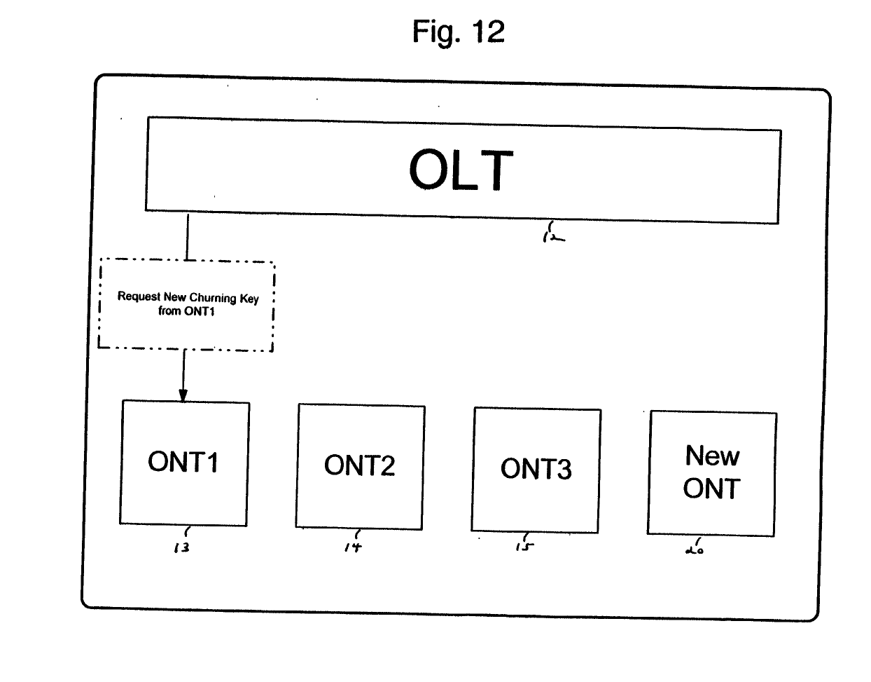

FIGS. 2 to 5 illustrate the above-described method of distributing multicast churning keys. In FIG. 2, the OLT requests from all ONTs their unique churning keys. Because the APON system is a broadcast system, all the ONTs within the system will receive the request for churning keys. However, only the ONTs that are subscribers to the multicast session, and therefore has registered with the EMS 11 and has received the proper VPI/VCI, may respond to the OLT's request for churning keys. In FIG. 2, all the ONTs 13, 14, and 15 are subscribers to the multicast session. The OLT 12 in FIG. 12 sends a churning key request to all the ONTs, which responds to the request by sending back to the OLT their individual churning keys (as shown in FIG. 3). Upon receiving the churning keys (as shown in FIG. 4) from the subscribing ONTs, the OLT selects a common, multicast, churning key and sends the churning key to all the subscribing ONTs. As shown in FIG. 5, once the multicast key is delivered to all the subscribing ONTs, the OLT can then begin multicasting to the subscribing ONTs using the new multicast churning key.

As previously mentioned, in accordance with the preferred embodiment of the present invention, the multicast key may be the churning key of the multicast group leader ONT, which may be selected in any manner. In accordance with the preferred embodiment, the group leader ONT is preferably the first ONT to respond to the OLT churning key request. The OLT may either deliver to the ONTs the common multicast key in coded format (i.e., in encrypted format); or, the OLT may deliver the multicast key to a subscribing ONT via a XOR product that is derived from the multicast key and the individual ONTs' churning key, which is stored in the OLT from the initial request of churning keys. As previously mentioned the individual ONTs may derive the multicast key by using the XOR product and its own churning key.

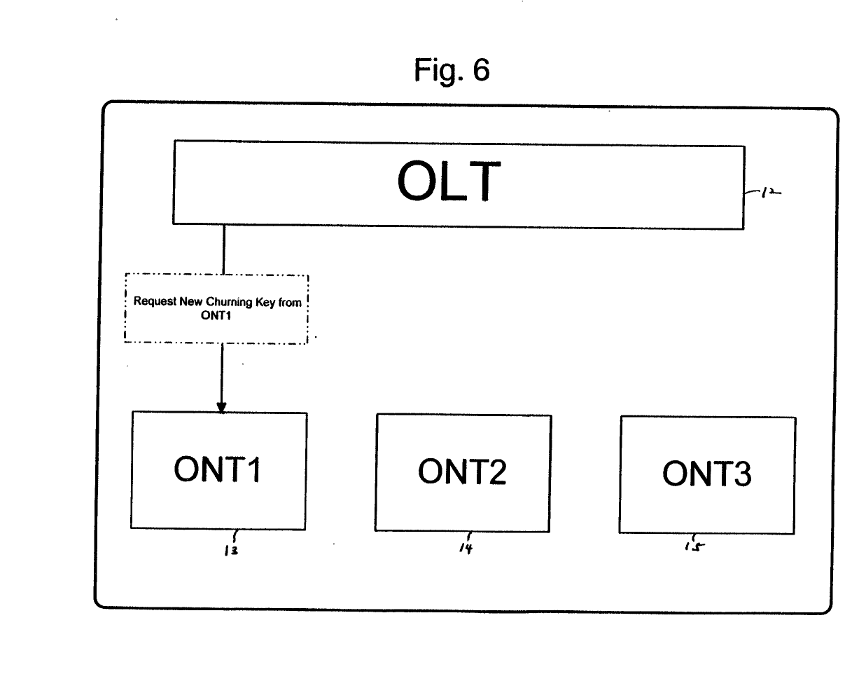

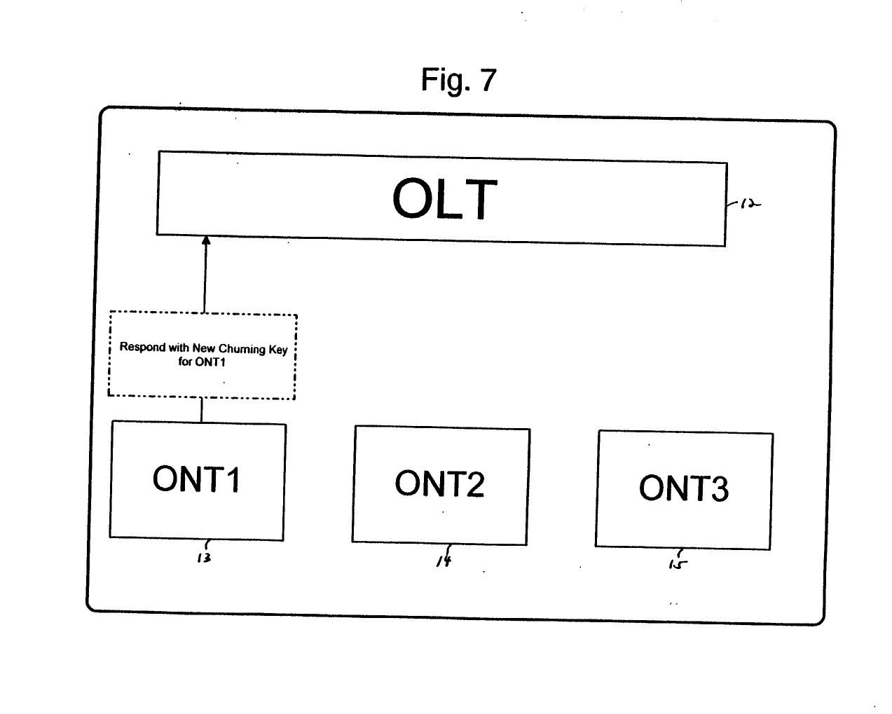

FIGS. 6 to 9 illustrate a method of updating multicast churning keys in accordance with the preferred embodiment of the present invention. At any given update churning key interval, which may be set at the OLT level, the OLT will only request a group member ONT, preferably the group leader ONT, to send a new churning key. In FIG. 6, the OLT requests a new churning key from ONT1, which responds to the OLT by sending to it a new churning key (as shown in FIG. 7). The OLT can then send to all the subscribing ONTs the new churning key as the updated multicast key. In another embodiment of the present invention, the OLT may send to the subscribing ONTs the XOR product derived from the new churning key and the stored subscribing ONT churning keys.

When a subscribing ONT goes out of service, quits the group, or unsubscribes to the service, the OLT will be informed so that the OLT will stop sending churning key updates to that ONT. The ONT's churning key stored in the OLT will be deleted. No other actions are needed unless the ONT leaving the group was the multicasting group leader. If the un-subscribing ONT is the multicasting group leader, then the process of selecting a leader will execute again, and another member ONT will be designated as the group leader.

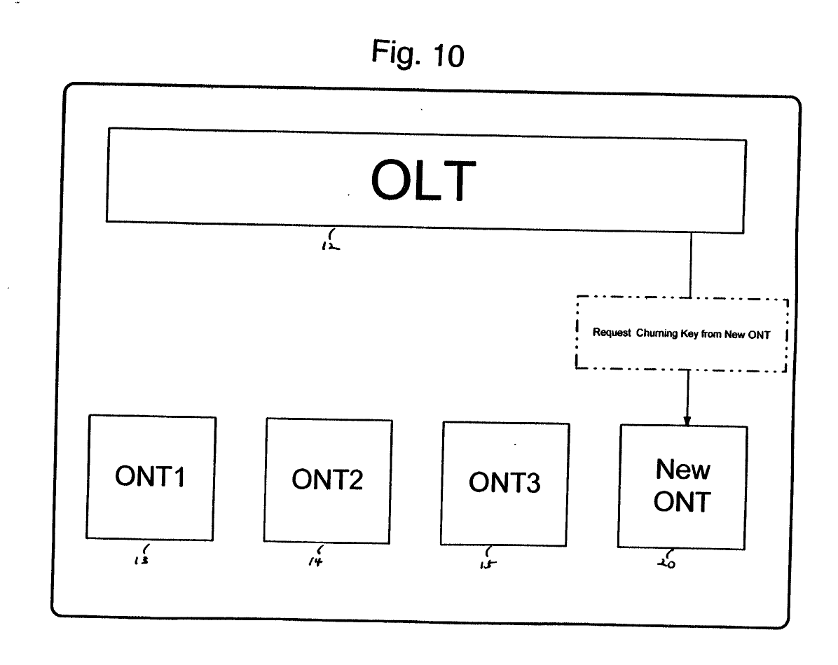

FIGS. 10 to 15 illustrate a method of adding a new ONT to the multicast subscribing group in accordance with the preferred embodiment of the present invention.

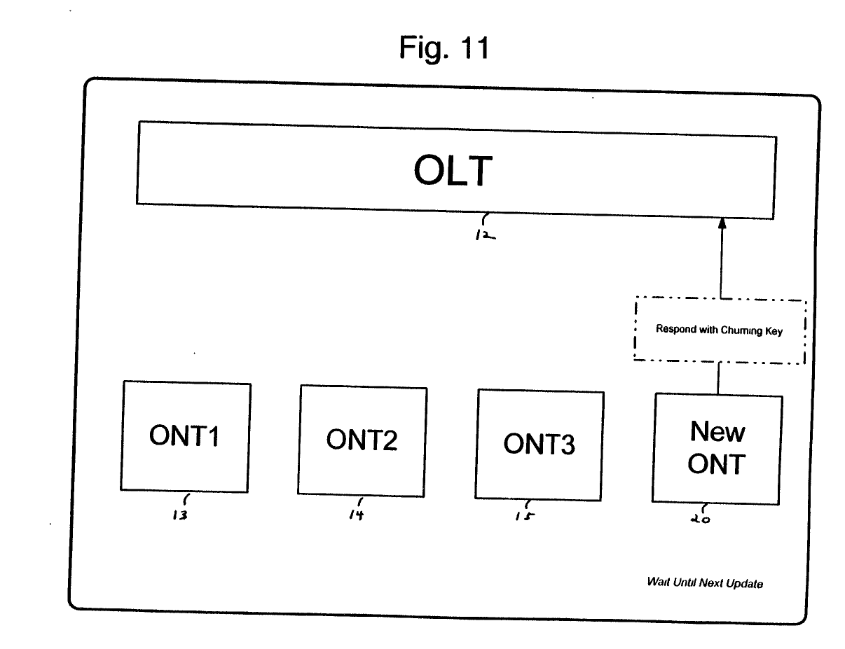

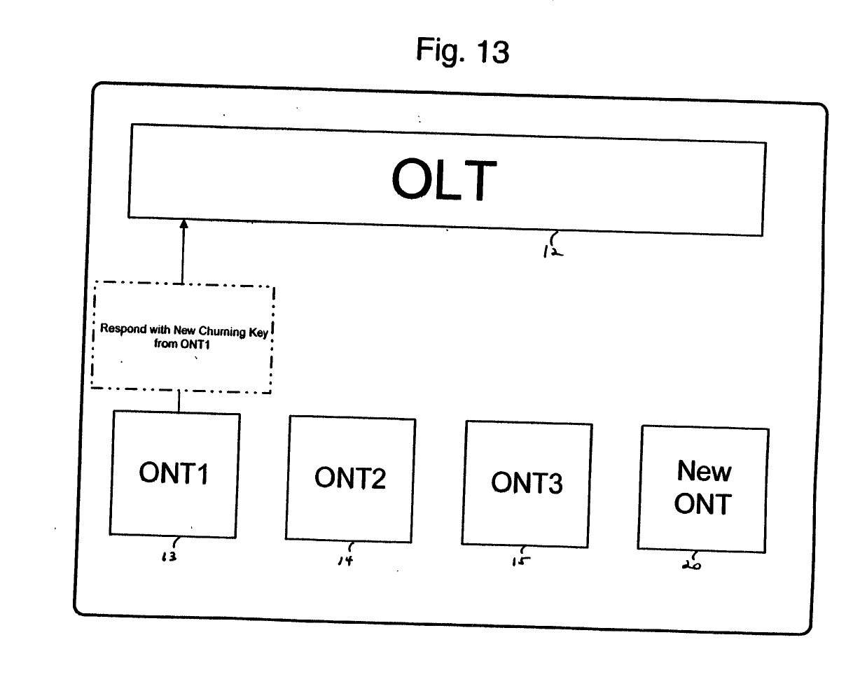

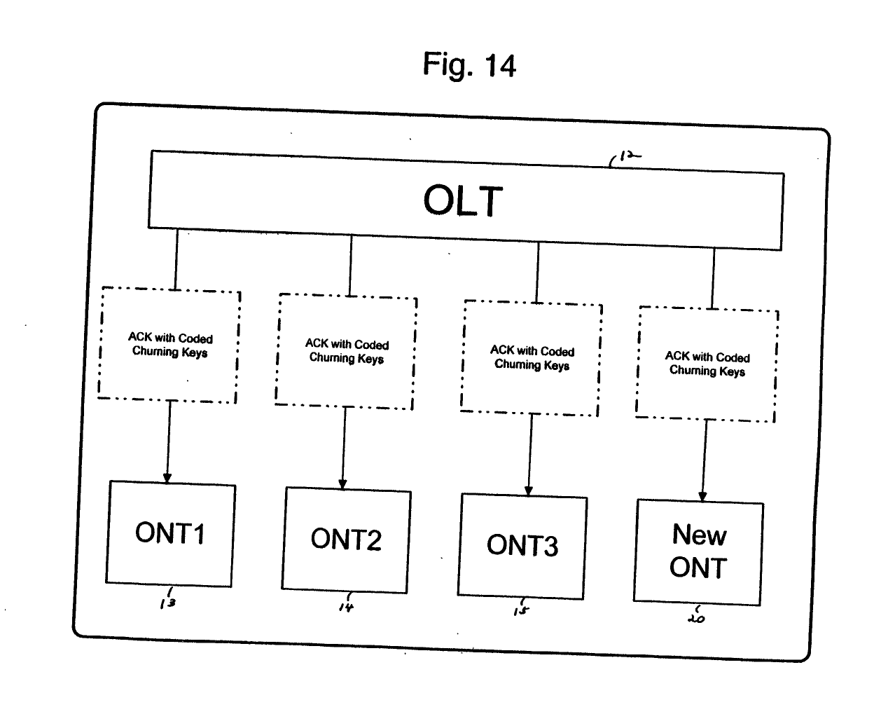

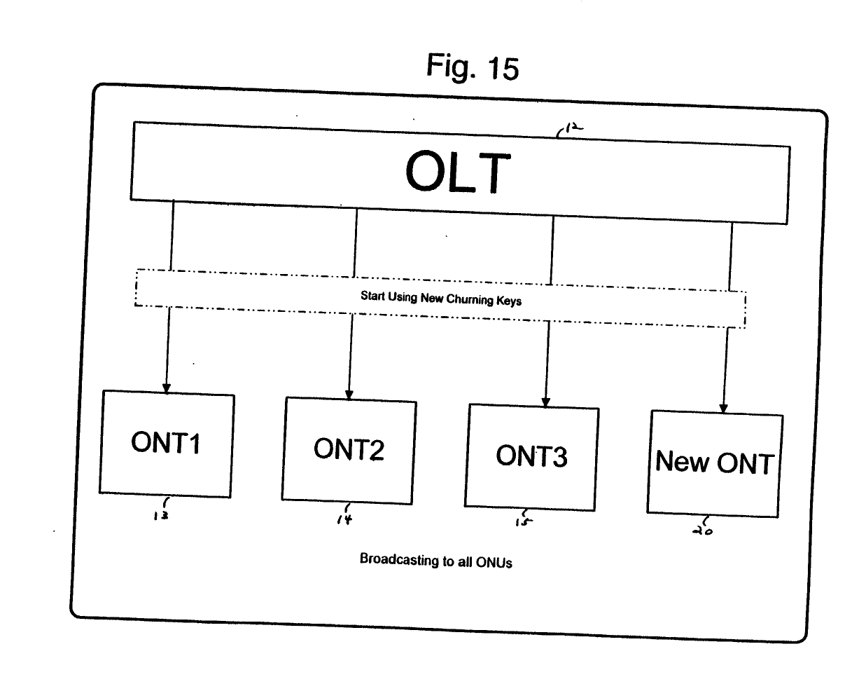

When a new ONT 20 is connected to the ODN (Optical Distribution Network) and becomes registered to be a subscribing member of the multicast group, the OLT 12 will be informed after the ONT is properly provisioned with the EMS 11. Upon proper provisioning, the OLT will send a churning key request to the new ONT (as shown in FIG. 10). In response to the churning key request, the new ONT 20 will respond by sending the OLT its own unique churning key (as shown in FIG. 11). After receiving the churning key, OLT preferably waits until the next scheduled update churning key time to send the churning key update to new ONT 20. FIG. 12 shows the OLT, upon a churning key update interval, requesting a new churning key from ONT1, which in this case is the designated group leader ONT. ONT1 then responds by sending to the OLT a new churning key (as shown in FIG. 13), after which the OLT distributes the updated churning key, or the XOR product thereof, to all the subscribing ONTs including the newly joined new ONT 20 (as shown in FIG. 14). Multicast data is thereafter encoded with the newly updated churning key before broadcasting to all the ONTs in the ODN (as shown in FIG. 15).

In accordance with the preferred embodiment of the present invention, if churning keys received from the ONTs at the OLT are not consistent, or if multiple transmissions of the churning key sent to an OLT are not identical, then the OLT will request the ONT to send again. If the second request fails, the particular ONT is preferably not included in multicasting group. At the same time, if churning key updates are not consistent, or if multiple transmissions of a multicasting churning key update are not identical, then the ONT will request the OLT to send again. If the second request fails, the ONT will inform the OLT of the failure. The OLT will then send failure information to EMS for requesting action.

In an alternative embodiment of the present invention, no group leader ONT need necessarily be selected for purposes of choosing a multicast churning key. Rather, after the OLT receives the churning keys from their respective registered ONTs, the OLT can itself generate a multicast churning key. The OLT can than deliver the self-generated multicast key by sending to each subscribing ONTs the XOR product between the generated multicast churning key and the respective ONT's own churning keys. As previously mentioned, various methods may be used to deliver the multicast key, XOR product being one of such methods. Other methods can include sending the difference, the AND product, the OR product, or any reversible function between the selected/generated multicast key and each ONT's own churning key.

In accordance with another alternative embodiment of the present invention, no multicast group leader needs to be selected. In such an embodiment, rather than choosing a multicast group leader and transmitting its churning key to the rest of the multicast group members, the OLT will simply generate a common churning key on its own. The common key need not be distributed to the rest of the subscribing ONTs. Rather, the OLT can deliver the common key by sending to the ONTs the XOR product between the common key and the ONTs' own churning keys. Again, although XOR function is used as the preferred method of delivering the churning keys, any other mathematical relationship may be used, so long as the ONTs are informed beforehand the function that is required to derive the common multicast key.

It should be noted that the present invention might be embodied in forms other than the preferred embodiments described above without departing from the spirit or essential characteristics thereof. The preferred embodiments are therefore to be considered in all aspects as illustrative and not restrictive, and all changes or alternatives that fall within the meaning and range or equivalency of the claims are intended to be embraced within them. For instance, as mentioned above, although the preferred embodiment of the present invention uses the XOR product as a method of delivering churning key updates, any logical operation, including addition or subtractions, may be used to deliver the difference between the multicast churning key and the individual ONT's own churning key.

What we claim:

1. A method for multicasting in an asynchronous transfer mode based passive optical network communication system, said method comprising the steps of:
requesting from a plurality of network devices to receive a plurality of encryption keys, wherein each network device is requested to send one encryption key;
receiving a plurality of encryption keys from said plurality of network devices, wherein one encryption key is received from each said network device;
selecting, from among the plurality of received encryption keys, one encryption key as a multicast encryption key for communicating with said plurality of network devices;
communicating with said plurality of network devices using said selected encryption key.

2. The method for multicasting according to claim 1, further comprising the step of sending to each of said plurality of network devices the selected encryption key.

3. The method for multicasting according to claim 1, further comprising the step of registering said plurality of network devices as members of a multicast group.

4. The method for multicasting according to claim 1, further comprising the step of assigning said plurality of network devices with virtual path identifications.

5. The method for multicasting according to claim 1, further comprising the step of assigning said plurality of network devices with virtual channel identifications.

6. The method for multicasting according to claim 1, further comprising the steps of:
altering said multicast encryption key;
sending said altered multicast encryption key to said plurality of network devices.

7. The method for multicasting according to claim 1, further comprising the steps of:
selecting an update multicast encryption key;
deriving a difference between the update multicast key and each of the received plurality of encryption keys;
sending to each of said plurality of network devices the derived difference between the update multicast key and the respective encryption key received from each of said plurality of network devices.

8. The method for multicasting according to claim 1, further comprising the step of designating a network device to be a multicast group leader.

9. The method according to claim 8, further comprising the step of requesting a new encryption key from said multicast group leader.

10. A method for multicasting in an asynchronous transfer mode based passive optical network communication system, said method comprising the steps of:
receiving a request to send an encryption key;
sending a first encryption key;
receive an acknowledgment signal;
receiving a second encryption key;

11. The method according to claim 10, further comprising the step of registering to be a member of a multicast group.

12. The method according to claim 10, wherein said first and second encryption keys are identical.

13. The method according to claim 10, wherein said first and second encryption keys are different.

14. The method according to claim 10, wherein said second encryption key is the XOR product between said first encryption key and a third encryption key.

15. The method according to claim 10, further comprising the step of deriving a third encryption key.

16. The method according to claim 15, wherein said third encryption key is derived using said first and second encryption keys.

17. The method according to claim 15, further comprising the step of using said third encryption key to decrypt incoming data transmission.

18. A central network device for use in an asynchronous transfer mode based passive optical network communication system, said central network device being programmed to execute the steps of:
requesting from a plurality of network devices to receive a plurality of encryption keys, wherein each network device is requested to send one encryption key;
receiving a plurality of encryption keys from said plurality of network devices, wherein one encryption key is received from each said network device;
selecting, from among the plurality of received encryption keys, one encryption key as a multicast encryption key for communicating with said plurality of network devices;
communicating with said plurality of network devices using said selected encryption key.

19. The central network device of claim 18, wherein the central network device is further programmed to execute the step of sending to each of said plurality of network devices the selected encryption key.

20. The central network device of claim 18, wherein the central network device is further programmed to execute the step of registering said plurality of network devices as members of a multicast group.

21. The central network device of claim 18, wherein the central network device is further programmed to execute the step of assigning said plurality of network devices with virtual path identifications.

22. The central network device of claim 18, wherein the central network device is further programmed to execute the step of assigning said plurality of network devices with virtual channel identifications.

23. The central network device of claim 18, wherein the central network device is further programmed to execute the steps of:
altering said multicast encryption key;
sending said altered multicast encryption key to said plurality of network devices.

24. The central network device of claim 18, wherein the central network device is further programmed to execute the steps of:
selecting an update multicast encryption key;
deriving a difference between the update multicast key and each of the received plurality of encryption keys;
sending to each of said plurality of network devices the derived difference between the update multicast key and the respective encryption key received from each of said plurality of network devices.

25. The central network device of claim 18, wherein the central network device is further programmed to execute the steps of designating a network device to be a multicast group leader.

26. The central network device of claim 18, wherein the central network device is further programmed to execute the steps of requesting a new encryption key from said multicast group leader.

27. The central network device of claim 18, wherein said central network device is an optical line terminal.

28. A network device for use in an asynchronous transfer mode based passive optical network communication system, said central network device being programmed to execute the steps of:
receiving a request to send an encryption key;
sending a first encryption key;
receive an acknowledgment signal;
receiving a second encryption key;

29. The network device according to claim 28, wherein said network device is an optical network unit.

30. The network device according to claim 28, wherein said network device is further programmed to perform the step of registering to be a member of a multicast group.

31. The network device according to claim 28, wherein said network device is further programmed to perform the step of deriving a third encryption key.

32. The network device according to claim 31, wherein said third encryption key is derived using said first and second encryption keys.

33. A method for multicasting in an asynchronous transfer mode based passive optical network communication system, said method comprising the steps of:
requesting from a plurality of network devices to receive a plurality of encryption keys, wherein each network device is requested to send one encryption key;
receiving a plurality of encryption keys from said plurality of network devices, wherein one encryption key is received from each said network device;
generating a multicast encryption key;
calculating a plurality of difference values between the generated multicast encryption key and each of said received plurality of encryption keys;
sending to each of said plurality of network devices the difference value between the multicast encryption key and the encryption key of the respective network device;
communicating with said plurality of network devices using said multicast encryption key.

34. A central network device for use in an asynchronous transfer mode based passive optical network communication system, said central network device being programmed to perform the steps of:
requesting from a plurality of network devices to receive a plurality of encryption keys, wherein each network device is requested to send one encryption key;
receiving a plurality of encryption keys from said plurality of network devices, wherein one encryption key is received from each said network device;
generating a multicast encryption key;
calculating a plurality of difference values between the generated multicast encryption key and each of said received plurality of encryption keys;
sending to each of said plurality of network devices the difference value between the multicast encryption key and the encryption key of the respective network device;
communicating with said plurality of network devices using said multicast encryption key.
